(19) United States
(12) Patent Application Publication
(10) Pub. No.: US 2016/0159009 A1
(43) Pub. Date: Jun. 9, 2016

(54) COMBINED THERMAL AND UV/VISIBLE LIGHT CURING STEREOLITHOGRAPHY

(71) Applicant: Philip L. Canale, Chelmsford, MA (US)

(72) Inventor: Philip L. Canale, Chelmsford, MA (US)

(21) Appl. No.: 14/960,594

(22) Filed: Dec. 7, 2015

Related U.S. Application Data
(60) Provisional application No. 62/087,832, filed on Dec. 5, 2014.

(51) Int. Cl. B29C 67/00; C09D 167/04; C09D 167/00; C09D 171/00; C09D 133/14; C09D 167/06

(52) U.S. Cl. CPC B29C 67/0066; C09D 133/14; C09D 167/06; C09D 167/00; C09D 171/00; C09D 167/04; B29K 2063/00

(57) ABSTRACT

A process, material, and apparatus are provided for effectuating thermal stereolithography utilizing combined thermal and ultraviolet and/or visible light curing. In an embodiment, the process may include providing a material including a thermoplastic component and a thermosetting component. The process may also include heating the material to at least partially flow the thermoplastic component. The process may also include dispensing the material in a plurality of layers to form a desired three dimensional object. The process may further include illuminating the material with electromagnetic radiation to at least partially polymerize the thermosetting component.

### CROSS-REFERENCE TO RELATED APPLICATION

This application claims the benefit of U.S. provisional patent application Ser. No. 62/087,832, filed on Dec. 5, 2014, entitled “Combining Thermal and UV/Visible light Curing Stereolithography to Produce a Thermoset, an Interpenetrating Polymer Network, a Semi-Interpenetrating Polymer Network, or a Pseudo-Interpenetrating Polymer Network,” the entire disclosure of which is incorporated herein by reference.

### TECHNICAL FIELD

The present disclosure generally relates to thermal stereolithography, and more particularly relates to thermal stereolithography utilizing thermal dispensing method and ultraviolet and/or visible light curing or crosslinking.

### BACKGROUND

3D printing or additive manufacturing is a process of making three dimensional solid objects from a digital tile. The creation of a 3D printed object may be achieved using additive processes. In an additive process an object may be created by laying down successive layers of material until the entire object is created. Each of these layers can be seen as a thinly sliced horizontal cross-section of the eventual object.

### SUMMARY

According to an implementation a process is provided for thermal stereolithography utilizing combined thermal and ultraviolet, and/or visible light, curing. The process may include providing a material including a thermoplastic component and a thermosetting component. The process may also include heating the material to at least partially flow the thermoplastic component. The process may also include dispensing the material in a plurality of layers to form a desired three dimensional object. The process may further include illuminating the material with one or more of ultraviolet and visible light to at least partially polymerize the thermosetting component.

One or more of the following features may be included. The material may include a separate thermoplastic component and thermosetting component. The material may include a mixture of a thermoplastic component and a thermosetting component. The material may include a thermoplastic component having cross-linkable thermosetting functionalities. The thermosetting component may include one or more of a monomer, a dimer, a trimer, and a partially pre-polymerized material. The material may be provided as a filament having a diameter between about 0.2 mm to about 5.0 mm.

The material may include a mixture including two or more of: i) one of an epoxy resin, a hydroxyl functionalized polymer, and a glycidyl ether functionalized polymer; ii) a thermoplastic resin; iii) an epoxy; iv) a vinyl ether functional monomer, dimmer, trimer, tetramer, pentamer, hexamer, heptomer, or octomer of a vinyl ether functional material; v) a divinylbenzene, secondary or tertiary hydroxyl functionalized lower molecular weight liquid polymer; vi) an epoxy functionalized lower molecular weight material; vii) a photosensitive cationic curing agent; vii) a sensitizer. The material may include a mixture of two or more of: i) an acrylate functionalized polymer capable of being further polymerized by a free radical photoinitiator; ii) an olefin functionalized polymer capable of being further polymerized by a free radical photoinitiator; iii) a bismaleimide resin; iv) a thermoplastic resin; v) one or more of an acrylate functional monomer, dimmer, trimer, tetramer, pentamer, hexamer, heptomer, octomer, and hexamer; vi) a styrene functionalized material including divinylbenzene; vii) an olefin functionalized lower molecular weight liquid polymer; viii) a photosensitive free radical curing agent; and ix) a sensitizer including one or more of a dye, and anthracene, and a derivatives thereof, capable of acting to extend the frequency curing range of a free radical curing agent to a longer wave length. The material may include one or more of a filler and reinforcement.

Dispensing the material in a plurality of layers may include at least partially fusing adjacent layers. Dispensing the material in a plurality of layers may include heating and dispensing the material via a nozzle. At least partially polymerizing the thermosetting material may include cross-linking one or more functional moieties of the thermosetting component. At least partially polymerizing the thermosetting component may include at least partially polymerizing one or more of a monomer, a dimer, a trimer, and a low molecular weight polymer. At least partially polymerizing the thermosetting component may include a free radical photopolymerization mechanism.

Illuminating the material may include illuminating a printing compartment in which the material is dispensed. Heating the material may include heating the material within a printing nozzle. Illuminating the material may include illuminating the material inside of the printing nozzle. Dispensing the material may include dispensing the material from a printing nozzle. Illuminating the material may include illuminating the material dispensed from the printing nozzle.

According to another implementation, a material may be provided. The material may include a filament capable of being used in a thermal stereolithography process. The filament may include at least a thermoplastic component and a thermosetting component.

One or more of the following features may be included. The filament may include a mixture including two or more of: i) one of an epoxy resin, a hydroxyl functionalized polymer, and a glycidyl ether functionalized polymer; ii) a thermoplastic resin; iii) an epoxy; iv) a vinyl ether, functional monomer, dimmer, trimer, tetramer, pentamer, hexamer, heptomer, or octomer of a vinyl ether functional material; v) a divinylbenzene, secondary or tertiary hydroxyl functionalized lower molecular weight liquid polymer; vi) an epoxy functionalized lower molecular weight material; vii) a photosensitive cationic curing agent; vii) a sensitizer. The filament may include a mixture of two or more of: i) acrylate functionalized polymer capable of being further polymerized by a free radical photoinitiator; ii) an olefin functionalized polymer capable of being further polymerized by a free radical photoinitiator; iii) a bismaleimide resin; iv) a thermoplastic resin; v) one or more of an acrylate functional monomer, dimmer, trimer, tetramer, pentamer, hexamer, heptomer, octomer, and hexamer; vi) a styrene functionalized material including divinylbenzene; vii) an olefin functionalized lower molecular weight liquid polymer; viii) a photosensitive free radical curing agent; and ix) a sensitizer including one or more of a dye, and anthracene, and a derivatives thereof, capable of acting to extend the frequency curing range of a free radical curing agent to a longer wave length.

### BRIEF DESCRIPTION OF THE DRAWINGS

FIG. 1 schematically depicts an illustrative embodiment of thermal stereo lithography apparatus, according to an example embodiment;

FIG. 2 schematically depicts a nozzle and illumination configuration according to an example embodiment;

FIG. 3 schematically depicts a nozzle and illumination configuration according to an example embodiment;

FIG. 4 schematically depicts a nozzle and illumination configuration according to an example embodiment; and

FIG. 5 schematically depicts a nozzle and illumination configuration according to an example embodiment.

### DESCRIPTION OF EXAMPLE EMBODIMENTS

The present disclosure may generally provide a process, material, and apparatus for thermal stereolithography utilizing combined thermal dispensing and ultraviolet, and/or visible light, curing. In general, the process may include providing a material including a thermoplastic component and a thermosetting component. The process may also include heating the material to at least partially flow the thermoplastic component. The process may also include dispensing the material in a plurality of layers to form a desired three dimensional object. The process may further include illuminating the material with one or more of ultraviolet and visible light to at least partially polymerize the thermosetting component.

As generally used herein, thermal stereolithography, or 3-D filament printing, may refer to an additive manufacturing process in which a plastic (e.g., a polymer material) may heated to at least partially melt, or flow, the plastic. The at least partially melted plastic may be extruded through a nozzle and deposited on a modelled part in a series of layers (e.g., thermal dispensing). Each layer may generally conform to the shape of a corresponding cross-section, or slice, of the desired modelled part. The at least partially melted plastic extruded through the nozzle may adhere to a previous layer, for example by at least partially fusing with the previous layer, at least partially adhesively bonding with the previous layer, and/or otherwise bonding with the previous layer. As layers of the plastic material are successively built up, with each layer having a shape generally corresponding to a respective cross-section of the desired modelled part at a corresponding height or position on the desired modelled part, a solid, three-dimensional object may be formed in the shape of the desired modelled part.

Consistent with an illustrative example of the present disclosure, the material utilized for the thermal stereolithography process may generally be provided as a filament, e.g., which may be extruded through a printing nozzle (also referred to as a “nozzle”). The material may include a thermoplastic component, such that the thermoplastic component of the material may be at least partially melted as it is extruded through the nozzle. The material may be extruded as a plurality of successive layers that may be built-up to form the desired modelled part, with each successive layer at least partially adhering to a previous layer of the desired modelled part. The material may also generally include a thermosetting component that may be at least partially polymerized upon exposure to electromagnetic radiation within a desired wavelength (such as exposure to ultraviolet and/or visible light). In some embodiments, the thermosetting component may be at least partially polymerized through a photoinitiated free radical reaction. As used herein, at least partially polymerizing the thermosetting component may include polymerizing, or further polymerizing, a monomer, dimer, trimer, etc., or a higher polymer. Further, as used herein at least partially polymerizing the thermosetting component may include cross-linking at least a portion of the thermosetting component (e.g., either exclusively amongst the crosslinking component and/or between the crosslinking component and the thermoplastic component). As such, the at least partially polymerized thermosetting component, alone and/or in conjunction with the thermoplastic component, may form one or more of a cross-linked structure, an interpenetrating polymer network, a semi-interpenetrating polymer network, and a pseudo-interpenetrating polymer network. Consistent with some implementations, after illumination by ultraviolet and/or visible light (e.g., an at least partially polymerizing the thermosetting component) a modelled part may be formed at lower processing temperatures, may exhibit reduced shrinkage and part distortion, may allow for greater interlayer adhesion, may exhibit greater strength, may exhibit high temperature performance, and/or may exhibit greater dimensional stability as compared to parts formed via a conventional thermal stereolithography process. A material including a thermoplastic component and a thermosetting component may include a single material (e.g., including both thermoplastic components and thermosetting components), a mixture of materials (e.g., in which at least a portion of the thermoplastic component and at least a portion of the thermosetting component may be associated with different material within the mixture), and/or combinations thereof. Further, in some embodiments, the thermosetting component may additional exhibit at least some degree of thermoplastic properties.

According to some embodiments, the material utilized in a thermal stereolithography process may be provided as a filament, e.g., which may be extruded through a nozzle to form the successive layers. In some embodiments, a filament consistent with the present disclosure may include a combination of functionalized and nonfunctionalized materials. In some embodiments, the combination of functionalized and nonfunctionalized materials may have relatively lower molecular weight (e.g., as compared to materials utilized in conventional thermal stereolithography processes) and/or may use one or more relatively higher molecular weight materials, which may be plasticized by a low molecular weight reactive material. As discussed above, in some such embodiments, this may allow for relatively lower processing temperatures (e.g., as compared to conventional thermal stereolithography processes), which may reduce shrinkage and part distortion while allowing for greater interlayer adhesion. Further, the subsequent at least partial polymerization of the thermosetting component (e.g., which may include functionalized materials and/or other reactive materials) may include cross-linking of functional moieties and/or polymerization of monomers, dimers, trimers, etc., and/or lower polymers, may allow for greater strength, high temperature performance, and dimensional stability (e.g., as compared to many parts formed through conventional thermal stereolithography processes).

In some implementations, example materials considered in these formulations may include epoxy resins, which themselves may exhibit lower shrinkage and may be used as adhesives which embody their superior nature to allow the inter-layers to adhere to one another. Further, in some embodiments, polymer formulations and filaments formed from such formulations may be prepared from compositions that may contain any mixture of one or more of a functionalized high molecular weight thermoplastic polymer; a nonfunctionalized high molecular weight thermoplastic polymer; a low molecular weight functionalized monomer, dimmer, trimer, tetramer, or higher; a cationic or free radical initiator; and/or a filler or reinforcement or any similar ingredients used in formulation of thermoplastics or thermoset materials. Exposure to electromagnetic radiation, such as an ultraviolet or visible light source, may be applied during an in situ or immediate process that may cross-link or further polymerize at least one component in the mixture resulting in a thermoset material, an interpenetrating polymer network, a semi-interpenetrating polymer network, or a pseudo-interpenetrating polymer network. In some embodiments, the material and/or material formulations may also contain a sensitizer such as anthracene, stilbene or their derivatives or a sensitizing dye that may be capable of extending the excitation wavelength of the photoinitiator to longer wavelengths. The inclusion of the sensitizer or sensitizing dye may allow the cross-linking/polymerization by electromagnetic radiation to be extended to include wavelengths of electromagnetic radiation that may be provided by relatively less expensive and/or less hazardous light sources can be used.

According to various implementations, the present disclosure may not only extend the type of materials that can be used in thermal stereolithography, it may also provide a less expensive path to producing cross-linked thermoset materials and/or products from a thermal stereolithography process. In addition/as an alternative to producing cross-linked thermoset materials and/or products, an interpenetrating polymer network, a semi-interpenetrating polymer network, or a pseudo-interpenetrating polymer network may be created. In some embodiments, a typically relatively cheaper thermal stereolithography may be retrofitted to allow the formation of thermoset materials and/or products with a relatively minimum capital investment.

Plastics are generally considered to fall into two main categories: thermoplastic materials and thermoset materials. Thermoplastic materials can be melted or allowed to flow upon application of heat. After cooling, they can then later be remelted or reflowed upon another application of heat. Thermosets, after application of sufficient UV/visible light, heat, or other sufficient radiation, or other curing mechanism, can be fused into a mass that cannot be remelted or reflowed. Each type of material produces products with unique properties. In addition, an interpenetrating polymer network, a semi-interpenetrating polymer network, or a pseudo-interpenetrating polymer network, may be produced as result of combinations of materials and the subsequent cross-linking or further polymerization by the UV or visible light. Both thermoset and thermoplastic materials have been used in stereolithography. Some typical thermal stereolithography processes involve forcing thermoplastic filaments through a heated nozzle making the thermoplastic material flowable. This is a process known as extrusion. In a similar manner as discussed above, the extruded material may then be deposited layer by layer onto a platform to form an object. Thermal stereolithography using a thermoplastic filament involving simple extrusion through a nozzle is a relatively simple and inexpensive machine to produce. Other forms of stereolithography may be comparatively much more complex, involving the use of a laser, mirrors and more complex programming to cure the material producing a solid part. Thermoset polymer stereolithography parts are typically produced because particular material properties are required that cannot be produced or easily produced with thermoplastics.

The present disclosure relates to a method of and apparatus for rapid forming of a solid three-dimensional article using the simplicity of the extrusion of filaments via thermal stereolithography while achieving the advantages of a thermoset: an interpenetrating polymer network, a semi-interpenetrating polymer network, or a pseudo-interpenetrating polymer network material produced by curing the article formed by the extruded filament with ultraviolet or visible light. In various embodiments of the present disclosure, this may be accomplished by extruding a thermoplastic filament that contains polymers, monomers, and/or plasticizers and a curing agent, which can be activated by UV or visible electromagnetic radiation.

According to various embodiments, the electromagnetic radiation (e.g., ultraviolet and/or visible light) may be applied in many ways, for example by having the printing compartment lit with the electromagnetic radiation while all layers are being printed. For example, the printing compartment may include an illumination source emitting electromagnetic radiation at the activation wavelength of the curing agent. As such, once the filament has been extruded, e.g., in the course of building up one or more layers of the article being formed, the extruded material may be exposed to the electromagnetic radiation from the illumination source. The illumination source may include, for example, an incandescent light source, a fluorescent light source, and LED light source, or other source of electromagnetic ration capable of providing illumination within the activation wavelength of the curing agent.

In further embodiments, the electromagnetic radiation illumination may be incorporated into the nozzle or at the end of the nozzle at the point where the material is being dispensed. For example, the nozzle may include a window that is at least partially transparent to electromagnetic radiation in the activation wavelength of the curing agent. An appropriate illumination source may be arranged to provide electromagnetic radiation incident on the window. In such an implementation, the filament may be illuminated with electromagnetic radiation within the activation wavelength of the curing agent while the filament is at least partially within the nozzle. In an embodiment, the filament may be illuminated while the filament is at least partially within the nozzle prior to heating the material of the filament to flowable state, after the material of the filament has been heated to a flowable state, and/or as the material of the filament is being heated to a flowable state. As described above, any suitable illumination source may be utilized. The illumination source may be arranged to directly illuminate the window included with the nozzle. For example, the illumination source may include an LED illumination source that may be incorporated into the nozzle and/or disposed adjacent to the nozzle to provide electromagnetic radiation directly incident on the window. In a further embodiment, the illumination source may be locate remotely relative to the window, and the electromagnetic radiation may be directed to be incident on the window via a fiber optic, a light pipe, a prism, or other suitable arrangement for conveying electromagnetic radiation in the activation wavelength of the curing agent.

According to a further embodiment, an illumination source may be configured to illuminate the material of the filament as the material is being extruded from the nozzle and/or after the material has been extruded from the nozzle. For example, the illumination source may be configured to provide the electromagnetic radiation incident on the tip of the nozzle and/or incident on the deposition area to which material extruded from the nozzle may be deposited. As such, the material of the filament may be illuminated by the electromagnetic radiation as the material is being extruded from the nozzle, as the material is being deposited (e.g., on previously extruded layers) to form the article the is being formed, and/or after the material has been deposited (e.g., on previously extruded layers). According to various embodiments, the illumination source may be disposed adjacent to the tip of the nozzle to provide the desired illumination. For example, the illumination source may include an LED that may be located adjacent to the tip of the nozzle. Additionally/alternatively, the illumination source may be located remotely from the nozzle tip, and the electromagnetic radiation may be directed to the region of the nozzle tip via a fiber optic, a light pipe, a prism, or other suitable arrangement for conveying electromagnetic radiation in the activation wavelength of the curing agent.

As generally discussed above, at least the thermosetting component of the material may be at least partially polymerized (e.g., polymerized, cross-linked, and/or otherwise cured) upon exposure to electromagnetic radiation in the activation wavelength (e.g., ultraviolet and/or visible light). As such, it may be desirable to reduce and/or prevent unintended exposure of the material to such electromagnetic radiation (e.g., exposure of the filament prior to printing or melting of the material, etc.). Accordingly, in some embodiments the material may be protected to prevent and/or reduce exposure to the electromagnetic radiation prior to the intended and/or desired illumination. In an illustrative embodiment, the filament may be protected by a sheath or tube leading from the filament holder (e.g., the spool, or other arrangement) to the filament dispenser (e.g., the nozzle). The tube or sheath may be at least partially, if not completely, opaque to electromagnetic radiation in the activation wavelength of the thermosetting component. Additionally, it will be appreciated that arrangements other than a tube or sheath may be utilized to prevent and/or reduce undesired exposure of the material to electromagnetic radiation in the activation wavelength.

In some embodiments, the present disclosure may also allow for a somewhat inexpensive retrofitting of filament thermal stereolithography machines. The simplicity or complexity of the retrofit can be a function of the formulation, speed, accuracy, or part configurations produced.

The materials produced in some embodiments may be cross-linked primarily through electromagnetic radiation in the 1000 to 100 nm wavelength range. Curable compositions and mechanisms and their uses are well known in the art. Such material compositions may typically be used, for example, in protective coatings, pressure sensitive adhesives, printing inks, electrical insulating coatings, sealants, adhesives, molding compounds, wire insulations, textile coatings, laminates, impregnated tapes, etc.

In general materials consistent with the present disclosure may include a thermoplastic component and a thermosetting component. For example, the material may include a separate thermoplastic component and thermosetting component. Further, the material may include a mixture of a thermoplastic component and a thermosetting component. For example, the material may include a thermoplastic component having cross-linkable thermosetting functionalities. In some embodiments, the thermosetting component may include one or more of a monomer, a dimer, a trimer, and a partially pre-polymerized material. The material may be provided as a filament having a diameter between about 0.2 mm to about 5.0 mm.

According to a particular implementation, the material may include a mixture including two or more of: i) one of an epoxy resin, a hydroxyl functionalized polymer, and a glycidyl ether functionalized polymer; ii) a thermoplastic resin; iii) an epoxy; iv) a vinyl ether functional monomer, dimmer, trimer, tetramer, pentamer, hexamer, heptomer, or octomer of a vinyl ether functional material; v) a divinylbenzene, secondary or tertiary hydroxyl functionalized lower molecular weight liquid polymer; vi) an epoxy functionalized lower molecular weight material; vii) a photosensitive cationic curing agent; vii) a sensitizer, such as free radical curing agent, dye, stilbene derivative, or anthracene derivatives that may act to extend the frequency curing range of cationic curing agent to a longer wave length allowing for the cure by light in the visible frequency domain. Further, in some implementations, the material may include a mixture of two or more of: i) an acrylate functionalized polymer capable of being further polymerized (e.g., which may include being polymerized or cross-linked) by a free radical photoinitiator; ii) an olefin functionalized polymer capable of being further polymerized by a free radical photoinitiator, e.g., which may be of sufficiently high molecular weight to be formed as a filament; iii) a bismaleimide resin; iv) a thermoplastic resin; v) one or more of an acrylate functional monomer, dimmer, trimer, tetramer, pentamer, hexamer, heptomer, octomer, and hexamer; vi) a styrene functionalized material including divinylbenzene; vii) olefin functionalized lower molecular weight liquid polymer; viii) a photosensitive free radical curing agent; and ix) a sensitizer including one or more of a dye, and anthracene, and a derivatives thereof, capable of acting to extend the frequency curing range of a free radical curing agent to a longer wave length (allowing for the cure by light in the visible or a lower frequency domain). The material may also include one or more of a filler and reinforcement, such as carbon nanotubes, alumina, quartz, glass microspheres, red phosphorous, etc. that may produce enhanced properties such as strength, thermal conductivity, coefficient of thermal expansion, light weight, and flame retardancy respectively). In further embodiments, mixtures and/or combinations of any of the above components may be utilized.

Additional and/or alternative components that may be utilized may include one or more of poly(alkylene oxide) moieties to fix a delayed cure of UV curable epoxy compositions when exposed to UV radiation. Combinations of a UV activated and thermally activated catalyst that may be used to produce deep section cure epoxy resin compositions. In some implementations, such compositions may contain UV opaque fillers but may still be implemented to cure quickly upon the application of heat and UV radiation. Halogen onium salts, and onium salts of Group VA and VIA elements having an MF6-anion, where M is selected from P, As and Sb, may be used and may, in some situations, exhibit unusual activity under ultraviolet light. Such onium salts may be employed as cationic photoinitiators when used with a variety of organic resins and cyclic organic compounds. Polyether polyols, including polyethylene glycol and polypropylene glycol as flexibilizing agents may be utilized in connection with various heat cured epoxy resins. In some circumstances, such epoxy resins may utilize an acid catalyst and a bake cycle at temperatures of from 80° C. to about 210° C. In further implementations, the heat cured epoxy resins could be adapted using a UV activated acid curing agent. Further, polyether polyols may be utilized as a flexibilizing agent in cycloaliphatic epoxide resins having good electrical properties. In some implementations, the epoxy resin compositions may utilize organic acids to catalyze the cure at temperatures of from about 100° C. to about 200° C. UV curable compositions may also be provided by derivatizing an acrylic polymer with a derivatizing agent prepared from a hydroxy-functional acrylate monomer and a diisocyanate. These resins may be cured primarily through a free radical curing mechanism. Composition curable by radiation having a wavelength of 300 nm or more, may be provided having from about 1 to about 99% by weight of an unsaturated polymer or oligomer, from about 1 to about 99% by weight of an unsaturated epoxy acrylate, and one or more photoinitiators. Optionally one or more solvents may be included in the formulation. Ultraviolet curing oligomers and liquid compositions may also be based on acrylates, which cure with ultraviolet light in the presence of a photoinitiator. UV-curable adhesive silicone compositions may also be utilized, in which a photoactive catalyst may be utilized to cross-link a UV-curable adhesive silicone composition in a plastic solid state or a semi-solid state in an uncured state at room temperature.

The following materials are provided by way of example, and utilized in describing some particular illustrative example materials that may suitable be used in connection with thermal and UV/visible light curing thermal stereolithography. It will be appreciated that various other suitable materials may be utilized consistent with the present disclosure.

LOTADER AX8900 (available from Arkema Group)—Ethylene-methyl acrylate ester-glycidyl methacrylate-terpolymer

Epon 1009F (1009F) (available from Hexion Inc.)—A high molecular weight solid diglycidyl ether of bisphenol-A, having an epoxy equivalent weight (EEW) of 2,300 to 3,800.

Epon 1001F (1001F) (available from Hexion Inc.)—A low molecular weight solid diglycidyl ether of bisphenol-A, having an EEW of 525 to 550.

Phenoxy resin PKFE (available from InChem Corporation)—(PhO) A high molecular weight phenoxy resin with a number average molecular weight of 16,000 daltons.

Eponex 1510 (1510) (available from Hexion Inc.)—Low viscosity Cycloaliphatic Glycidyl Ether. having an EEW of 210 to 220.

Poly(caprolactone) (PCl)—with a weight average molecular weight of 80,000.

Araldite CY179 (CY179) (available from Ciba Specialty Chemicals)—a cycloaliphatic epoxy resin with an EEW of 131 to 143.

Sartomer SR399 (SR399) (available from Arkema Inc.)—Dipenaerythritolpentacrylate.

UVECoat 9010 (9010) (available from Allnex Belgium SA/NV)—a semi-crystalline unsaturated polyester resin.

UVECoat 2100 (2100) (available from Allnex Belgium SA/NV)—an amorphous unsaturated polyester resin.

Irgacure 819 (IR819) (available from Ciba Specialty Chemicals)—Bis(2,4,6-trimethylbenzoyl)-phenylphospineoxide

Esacure KIP100F (KIP100F) (available from Lehmann & Voss & Co.)—1-Propanone, 2-hydroxy-2-methyl-1-4-(1-methylethyenyl)pheyl-, homopolymer, mixed with 2-hydroxy-2-methyl-1-phenyl-1-propanone.

Anthracure UVS-1331 (UVS-1331) (available from Kawasaki Kasei Chemicals Ltd.)—9,10-Dibutoxyanthracene.

Deuteron UV1240 (UV1240) (available from Deuteron GmbH)—bis (4-dodecylphenyl) iodonium hexafluoroantimonate

Cyracure UVI-6992 (UVI6992) (available from Dow Chemical Company)—a mixture of tialsulfonium hexafluorophosphate salts in propylene carbonate.

Vitel 2200B (2200B) (available from Bostik Inc.)—a co-polyester thermoplastic polymer made by Bostik Inc.

Sartomer SR495B (SR499B) (available from Arkema Inc.)—Polycaprolactone acrylate with hydroxyl functionality.

Desmodure I (DI) (available from Covestro AG)—Isophorone diisocyanate

### EXAMPLE 1

Mix 100 parts by weight of LOTADER AX8900 5 parts by weight of CY179 with 1 part by weight of UV1240 and 0.5 parts of IR819 by feeding into a twin-screw extruder at 120° C. pelletized and then extruded into a 1.75 mm filament.

### EXAMPLE 2

Mix 80 parts by weight of 2100 with 20 parts by weight of 9100, 5 parts by weight of KIP100F, 5 parts by weight of SR399, and 0.5 parts by weight of UVS-1331 by feeding into a twin-screw extruder at 140° C. pelletized and then extruded again into a 1.75 mm filament.

### EXAMPLE 3

Mix 100 parts by weight of 2200B with 10 parts by weight of SR399 5 parts by weight of KIP100F and 2 parts by weight of 819 by feeding into a twin-screw extruder at 160° C. pelletized and then extruded again into a 1.75 mm filament.

### EXAMPLE 4

Mix 100 parts by weight of PhO with 10 parts by weight of 1009F, 5 parts by weight of 1001F, 5 parts by weight of 1510, 0.75 parts by weight of UVI6992 and 1 part by weight of UVS-1331 by feeding into a twin-screw extruder at 140° C. pelletized and then extruded again into a 1.75 mm filament.

EXAMPLE 5

Mix 10 parts by weight of SR495B with 3.30 parts by weight of DI and let react overnight. Mix this with 100 parts by weight of PCl, 5 parts by weight of KIP100F and 2 parts by weight of 819 by feeding into a twin-screw extruder at 100° C. pelletized and then extruded again into a 1.75 mm filament.

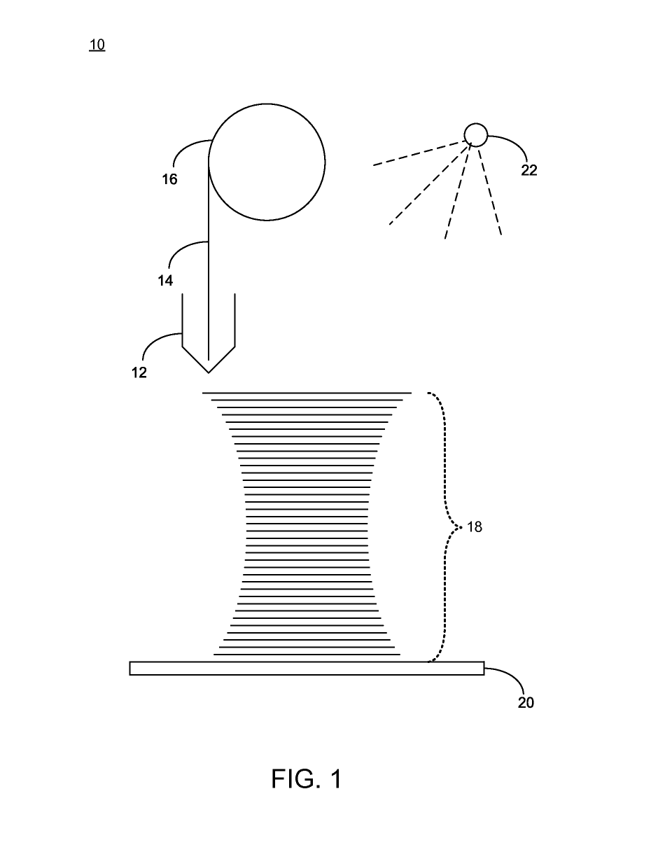

Consistent with various illustrative embodiments, the plastic material may be provided to the nozzle in the form of a filament or rod, which may be at least partially melted within the nozzle. For example, and referring to FIG. 1, a thermal stereolithography apparatus 10 according to an example embodiment may include a nozzle 12. Plastic filament 14 may be fed into the nozzle 10, for example, from a spool 16 or other suitable supply. The plastic filament 14 may be heated by the nozzle 12 to at least partially melt the filament, and may be extruded from a tip of the nozzle 12 to form a series of sequentially applied layers (layers 18, generally). While not shown, as is commonly known, the nozzle may include one or more heating elements (such as resistive heating elements or the like), as well as one or more conveyance features (such as feed rollers acting on the filament, a ram or plunger, a screw conveyor, or the like), as well as various temperature controllers and feed-rate controllers. As generally discussed above, each layer may generally adhere to the previously applied layer. Each layer may have a shape that generally corresponds to the cross-sectional shape of the desired modelled part at a generally corresponding height. As such, the sequentially applied layers, which may be adhered to one another, may generally form the desired modeled part as a solid part. An initial layer may be formed on a platen 20, which may support the part being formed. The desired shape of each layer being formed (e.g., by extruding the at least partially melted filament) may be created by moving the nozzle 12 and the platen 20 relative to one another. In an embodiment, the nozzle 12 may be moved to create the desired shape of each layer which the platen 20 may remain stationary. In other embodiments, the nozzle 12 may remain stationary, and the platen 20 may move relative to the nozzle 12 to create the desired shape of each layer. In still further embodiments, both the nozzle 12 and the platen 20 may move relative to one another to create the desired shape of each layer. It will be appreciated that the resolution of the layers 18 may be varied depending upon the characteristics of the plastic and the operating parameters of the thermal stereolithography apparatus 10, with the layers 18 being coarsely depicted in FIG. 1 for the purpose of explanation. Various computer control systems and mechanical drive features may be utilized for moving the nozzle and/or the platen, as will be readily understood.

As described above, the filament may include a thermoplastic component and a thermosetting component. The filament 14 may be illuminated with an electromagnetic radiation, either before, during, or after extrusion of the filament to at least partially polymerize the thermosetting component of the filament 14. As also described above, the thermosetting component may include a monomer, dimer, trimer, or larger group. Illuminating the filament 14 may at least partially polymerize such monomers, dimers, trimers, or larger groups. Further, the thermosetting component may include one or more functionalized moieties that may participate in a cross-linking reaction. In such an embodiment, illuminating the filament 14 may initiate a cross-linking reaction in at least a portion of the functionalize moieties of the thermosetting component. In various embodiments, the electromagnetic radiation may include ultraviolet light, visible light, or other frequencies of electromagnetic radiation, dependent upon the characteristics of the thermosetting component as well as any initiators or sensitizers provided for facilitating polymerization of the thermosetting component.

With continued reference to FIG. 1, the thermal stereolithography apparatus 10 may include an illumination source 22 that may provide electromagnetic radiation in the desired frequency. As shown in the illustrative embodiment, the illumination source 22 may be provided in general proximity to the modelled part being formed. As such, the filament may be illuminated as each sequential layer is being extruded and/or after a portion, or all, of the modelled part has been formed. The illumination of the extruded filament may occur continuously and/or intermittently. While only a single illumination source 22 has been depicted, it will be appreciated that more than one illumination source may be utilized, e.g., to more uniformly illuminate the extruded filament and/or to increase the illumination intensity.

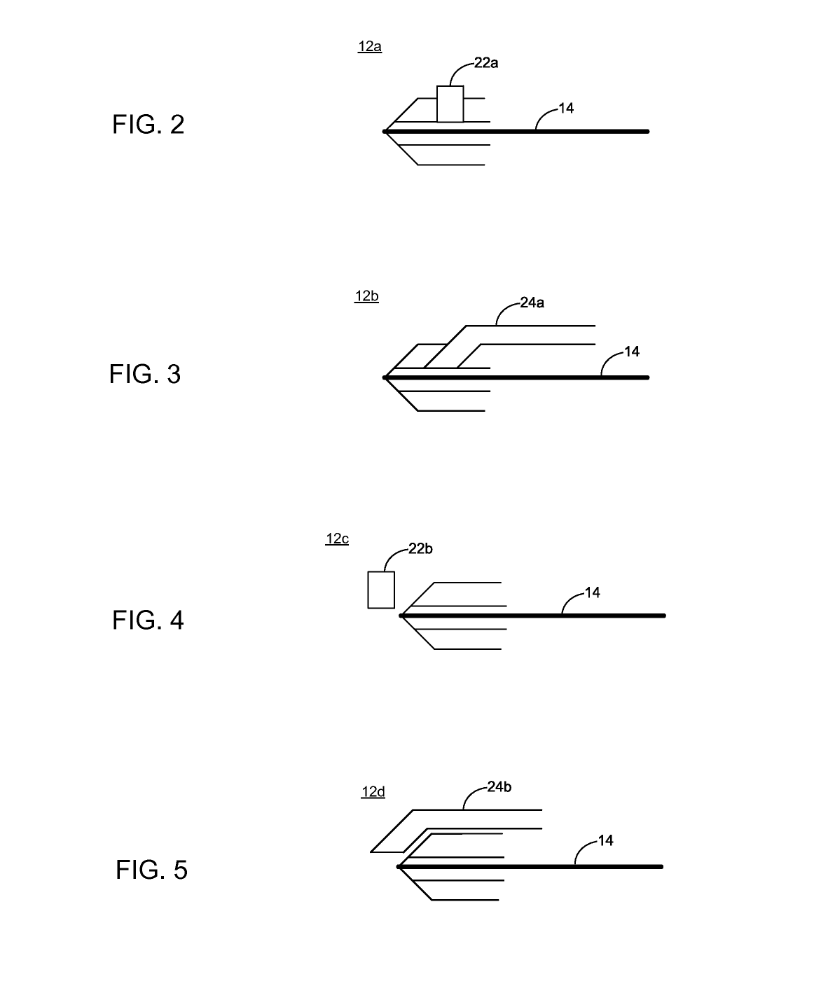

Referring generally to FIGS. 2-5, in some embodiments, the illumination source may be associated with the nozzle, such that the filament may be illuminated within the nozzle, and/or during or after extrusion of the at least partially melted filament. For example, referring to FIG. 2, the nozzle 12a may include an illumination source 22a that may be disposed to illuminate the filament 14 while the filament is within the nozzle 12a. In some such embodiments, the illumination source may be provided in or at an aperture in the nozzle 12a, or adjacent an optical window (e.g., which may be at least partially transparent to electromagnetic radiation in the desired wavelength) formed in the nozzle 12a. In further embodiments, at least a portion of the nozzle 12a may be at least partially transparent to the desired wavelengths of electromagnetic radiation. In such an embodiment, the illumination source 22a may be at least partially external to the nozzle. Further, and as shown in FIG. 3, in an embodiment the illumination source may be remote relative to the nozzle 12b. In such a configuration, a fiber optic 24a, light pipe, prism, or other optical conveyance, may be used to pass the electromagnetic radiation from the illumination source to the filament within the nozzle 12b. Similar to the previously described embodiment, the fiber optic 24a, or other optical conveyance may illuminate the filament via an aperture, optical window, or an at least partially transparent nozzle portion. Consistent with such an embodiment, the illumination source may be remote relative to the nozzle 12b, which may, for example, at least partially separate the illumination source from the heat of the nozzle, and/or other environmental effects of the extrusion process.

Referring to FIGS. 4 and 5, in another embodiment, the illumination source may be provided to illuminate the filament as it is being extruded from the nozzle and/or as, or after, the extruded filament has been applied to a previous layer of the modelled object. For example, as shown in FIG. 4, an illumination source 22b may be positioned in the region of the tip of the nozzle 12c. According to such an embodiment, the filament 14 may be illuminated as it is being extruded from the nozzle 12c, and/or as, or after, the filament 14 is applied to the previous layer of the modelled object. Further, as shown in FIG. 5, in an embodiment the illumination source may be remote relative to the nozzle 12d. The filament 14 may be illuminated by the electromagnetic radiation via a fiber optic 24b, light pipe, prism, or other optical conveyance as, or after, the filament is extruded from the nozzle 12d. As with the embodiment shown in FIG. 3, positioning the illumination source remote relative to the nozzle 12d may at least partially separate the illumination source from the heat of the nozzle, and/or other environmental effects of the extrusion process.

A variety of features of the variable flow rate pump have been described. However, it will be appreciated that various additional features and structures may be implemented in connection with a pump according to the present disclosure. As such, the features and attributes described herein should be construed as a limitation on the present disclosure.

What is claimed is:

1. A process comprising:
providing a material including a thermoplastic component and a thermosetting component;
heating the material to at least partially flow the thermoplastic component;
dispensing the material in a plurality of layers to form a desired three dimensional object; and
illuminating the material with electromagnetic radiation to at least partially polymerize the thermosetting component.

2. The process according to claim 1, wherein the material includes a separate thermoplastic component and thermosetting component.

3. The process according to claim 1, wherein the material includes a mixture of a thermoplastic component and a thermosetting component.

4. The process according to claim 1, wherein the material includes a thermoplastic component having cross-linkable thermosetting functionalities.

5. The process according to claim 1, wherein the thermosetting component includes one or more of a monomer, a dimer, a trimer, and a partially pre-polymerized material.

6. The process according to claim 1, wherein the material is provided as a filament having a diameter between about 0.2 mm to about 5.0 mm.

7. The process according to claim 1, wherein the material includes a mixture including two or more of: i) one of an epoxy resin, a hydroxyl functionalized polymer, and a glycidyl ether functionalized polymer; ii) a thermoplastic resin; iii) an epoxy; iv) a vinyl ether functional monomer, dimmer, trimer, tetramer, pentamer, hexamer, heptomer, or octomer of a vinyl ether functional material; v) a divinylbenzene, secondary or tertiary hydroxyl functionalized lower molecular weight liquid polymer; vi) an epoxy functionalized lower molecular weight material; vii) a photosensitive cationic curing agent; vii) a sensitizer.

8. The process according to claim 1, wherein the material includes a mixture of two or more of: i) an acrylate functionalized polymer capable of being further polymerized by a free radical photoinitiator; ii) an olefin functionalized polymer capable of being further polymerized by a free radical photoinitiator; iii) a bismaleimide resin; iv) a thermoplastic resin; v) one or more of an acrylate functional monomer, dimmer, trimer, tetramer, pentamer, hexamer, heptomer, octomer, and hexamer; vi) a styrene functionalized material including divinylbenzene; vii) an olefin functionalized lower molecular weight liquid polymer; viii) a photosensitive free radical curing agent; and ix) a sensitizer including one or more of a dye, and anthracene, and a derivatives thereof, capable of acting to extend the frequency curing range of a free radical curing agent to a longer wave length.

9. The process according to claim 1, wherein the material includes one or more of a filler and reinforcement.

10. The process according to claim 1, wherein dispensing the material plurality of layers includes at least partially fusing adjacent layers.

11. The process according to claim 1, wherein dispensing the material in a plurality of layers includes heating and dispensing the material via a nozzle.

12. The process according to claim 1, wherein the electromagnetic radiation includes one or more of ultraviolet light and visible light.

13. The process according to claim 1, wherein at least partially polymerizing the thermosetting material includes cross-linking one or more functional moieties of the thermosetting component.

14. The process according to claim 1, wherein at least partially polymerizing the thermosetting component includes at least partially polymerizing one or more of a monomer, a dimer, a trimer, and a low molecular weight polymer.

15. The process according to claim 1, wherein at least partially polymerizing the thermosetting component includes a free radical photopolymerization mechanism.

16. The process according to claim 1, wherein illuminating the material includes illuminating a printing compartment in which the material is dispensed.

17. The process according to claim 1, wherein heating the material includes heating the material within a printing nozzle, and illuminating the material includes illuminating the material inside of the printing nozzle.

18. The process according to claim 1, wherein dispensing the material includes dispensing the material from a printing nozzle, and illuminating the material includes illuminating the material dispensed from the printing nozzle.

19. A material comprising:
a filament capable of being used in a thermal stereolithography process, the filament including at least a thermoplastic component and a thermosetting component.

20. The material of claim 19, wherein the filament comprises a mixture including two or more of: i) one of an epoxy resin, a hydroxyl functionalized polymer, and a glycidyl ether functionalized polymer; ii) a thermoplastic resin; iii) an epoxy; iv) a vinyl ether functional monomer, dimmer, trimer, tetramer, pentamer, hexamer, heptomer, or octomer of a vinyl ether functional material; v) a divinylbenzene, secondary or tertiary hydroxyl functionalized lower molecular weight liquid polymer; vi) an epoxy functionalized lower molecular weight material; vii) a photosensitive cationic curing agent; vii) a sensitizer.

21. The material of claim 19, wherein the filament comprises a mixture of two or more of: i) an acrylate functionalized polymer capable of being further polymerized by a free radical photoinitiator; ii) an olefin functionalized polymer capable of being further polymerized by a free radical photoinitiator; iii) a bismaleimide resin; iv) a thermoplastic resin; v) one or more of an acrylate functional monomer, dimmer, trimer, tetramer, pentamer, hexamer, heptomer, octomer, and hexamer; vi) a styrene functionalized material including divinylbenzene; vii) an olefin functionalized lower molecular weight liquid polymer; viii) a photosensitive free radical curing agent; and ix) a sensitizer including one or more of a dye, and anthracene, and a derivatives thereof, capable of acting to extend the frequency curing range of a free radical curing agent to a longer wave length.
